(19) United States
(12) Patent Application Publication
(10) Pub. No.: US 2006/0140277 A1
(43) Pub. Date: Jun. 29, 2006

(54) METHOD OF DECODING DIGITAL VIDEO AND DIGITAL VIDEO DECODER SYSTEM THEREOF

(76) Inventor: Chi-Cheng Ju, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/905,336

(22) Filed: Dec. 28, 2004

(51) Int. Cl. H04N 11/02; H04N 7/12; H04N 11/04; H04B 1/66

(52) U.S. Cl. 375/240.25; 375/240.12

(57) ABSTRACT

A method for decoding pictures from a digital video bit-stream includes providing a first buffer and a second buffer being overlapped with the first buffer by an overlap region; decoding a first encoded picture from the bit-stream and storing a corresponding first picture into the first buffer; and decoding a second encoded picture from the bit-stream according to the first picture being stored in the first buffer, and storing a corresponding second picture into the second buffer. By overlapping the first buffer and the second buffer, overall buffer memory requirements when decoding the pictures are moderated.

### BACKGROUND

The invention relates to digital video decoding, and more particularly, to a method and system for digital video decoding having reduced frame buffering memory requirements.

The Moving Picture Experts Group (MPEG) MPEG-2 standard (ISO-1 381 8) is utilized with video applications. The MPEG-2 standard describes an encoded and compressed bit-stream that has substantial bandwidth reduction. The compression is a subjective loss compression followed by a lossless compression. The encoded, compressed digital video data is subsequently decompressed and decoded by an MPEG-2 standard compliant decoder.

The MPEG-2 standard specifies a bit-stream from and a decoder for a very high compression technique that achieves overall image bit-stream compression not achievable with either intraframe coding alone or interframe coding alone, while preserving the random access advantages of pure intraframe coding. The combination of block based frequency domain intraframe encoding and interpolative/predictive interframe encoding of the MPEG-2 standard results in a combination of intraframe encoding advantages and interframe encoding advantages.

The MPEG-2 standard specifies predictive and interpolative interframe encoding and frequency domain intraframe encoding. Block based motion compensation is utilized for the reduction of temporal redundancy, and block based Discrete Cosine Transform based compression is utilized for the reduction of spatial redundancy. Under the MPEG-2 standard, motion compensation is achieved by predictive coding, interpolative coding, and Variable Length Coded motion vectors. The information relative to motion is based on a 16×16 array of pixels and is transmitted with the spatial information. Motion information is compressed with Variable Length Codes, such as Huffman codes.

In general, there are some spatial similarities in chromatic, geometrical, or other characteristic values within a picture/image. In order to eliminate these spatial redundancies, it is required to identify important elements of the picture and to remove the redundant elements that are less important. For example, according to the MPEG-2 standard, a picture is compressed by eliminating the spatial redundancies by chrominance sampling, discrete cosine transform (DCT), and quantization. In addition, video data is actually formed by a continuous series of pictures, which are perceived as a moving picture due to the persistence of pictures in the vision of human eyes. Since the time interval between pictures is very short, the difference between neighboring pictures is very tiny and mostly appears as a change of location of visual objects. Therefore, the MPEG-2 standard eliminates temporal redundancies caused by the similarity between pictures to further compress the video data.

In order to eliminate the temporal redundancies mentioned above, a process referred to as motion compensation is employed in the MPEG-2 standard. Motion compensation relates to the redundancy between pictures. Before performing motion compensation, a current picture to be processed is typically divided into 16×16 pixel sized macroblocks (MB). For each current macroblock, a most similar prediction block of a reference picture is then determined by comparing the current macroblock with “candidate” macroblocks of a preceding picture or a succeeding picture. The most similar prediction block is treated as a reference block and the location difference between the current block and the reference block is then recorded as a motion vector. The above process of obtaining the motion vector is referred to as motion estimation. If the picture to which the reference block belongs is prior to the current picture, the process is called forward prediction. If the reference picture is posterior to the current picture, the process is called backward prediction. In addition, if the motion vector is obtained by referring both to a preceding picture and a succeeding picture of the current picture, the process is called bi-directional prediction. A commonly employed motion estimation method is a block-matching method. Because the reference block may not be completely the same with the current block, when using block-matching, it is required to calculate the difference between the current block and the reference block, which is also referred to as a prediction error. The prediction error is used for decoding the current block.

The MPEG 2 standard defines three encoding types for encoding pictures: intra encoding, predictive encoding, and bi-directionally predictive encoding. An intra-coded picture (I-picture) is encoded independently without using a preceding picture or a succeeding picture. A predictive encoded picture (P-picture) is encoded by referring to a preceding reference picture, wherein the preceding reference picture should be an I-picture or a P-picture. In addition, a bi-directionally predictive picture (B-picture) is encoded using both a preceding picture and a succeeding picture. Bi-directionally predictive pictures (B-pictures) have the highest degree of compression and require both a past picture and a future picture for reconstruction during decoding. It should also be noted that B-pictures are not used as reference pictures. Because I-pictures and P-pictures can be used as a reference to decode other pictures, the I-pictures and P-pictures are also referred to as reference pictures. As B-pictures are never used to decode other pictures, B-pictures are also referred to as non-reference pictures. Note that in other video compression standard such as SMPTE VC-1, B field pictures can be used as a reference to decode other pictures. Hence, the picture encoding types belonging to either reference picture or non-reference picture may vary according to different video compression standard.

As mentioned above, a picture is composed of a plurality of macro-blocks, and the picture is encoded macro-block by macro-block. Each macro-block has a corresponding motion type parameter representing its motion compensation type. In the MPEG 2 standard, for example, each macro-block in an I-picture is intra-coded. P-pictures can comprise intra-coded and forward motion compensated macro-blocks; and B-pictures can comprise intra-coded, forward motion compensated, backward motion compensated, and bi-directional motion compensated macro-blocks. As is well known in the art, an intra-coded macro-block is independently encoded without using other macro-blocks in a preceding picture or a succeeding picture. A forward motion compensated macro-block is encoded by using the forward prediction information of a most similar macro-block in the preceding picture. A bi-directional motion compensated macro-block is encoded by using the forward prediction information of a reference macro-block in the preceding picture and the backward prediction information of another reference macro-block in the succeeding picture. The formation of P-pictures from I-pictures, and the formation of B-pictures from a pair of past and future pictures are key features of the MPEG-2 standard.

FIG. 1 shows a conventional block-matching process of motion estimation. A current picture 120 is divided into blocks as shown in FIG. 1. Each block can be any size. For example, in the MPEG standard, the current picture 120 is typically divided into macro-blocks having 16×16 pixels. Each block in the current picture 120 is encoded in terms of its difference from a block in a preceding picture 110 or a succeeding picture 130. During the block-matching process of a current block 100, the current block 100 is compared with similar-sized “candidate” blocks within a search range 115 of the preceding picture 110 or within a search range 135l of the succeeding picture 130. The candidate block of the preceding picture 110 or the succeeding picture 130 that is determined to have the smallest difference with respect to the current block 100, e.g. a block 150 of the preceding picture 110, is selected as a reference block. The motion vectors and residues between the reference block 150 and the current block 100 are computed and coded. As a result, the current block 100 can be restored during decompression using the coding of the reference block 150 as well as the motion vectors and residues for the current block 100.

The motion compensation unit under the MPEG-2 Standard is the Macroblock unit. The MPEG-2 standard sized macroblocks are 16×16 pixels. Motion information consists of one vector for forward predicted macroblocks, one vector for backward predicted macroblocks, and two vectors for bi-directionally predicted macroblocks. The motion information associated with each macroblock is coded differentially with respect to the motion information present in the reference macroblock. In this way a macroblock of pixels is predicted by a translation of a macroblock of pixels from a past or future picture. The difference between the source pixels and the predicted pixels is included in the corresponding bit-stream. That is, the output of the video encoder is a digital video bit-stream comprising encoded pictures that can be decoded by a decoder system.

FIG. 2 shows difference between the display order and the transmission order of pictures of the MPEG-2 standard. As mentioned, the MPEG-2 standard provides temporal redundancy reduction through the use of various predictive and interpolative tools. This is illustrated in FIG. 2 with the use of three different types of frames (also referred to as pictures): “I” intra-coded pictures, “P” predicted Pictures, and “B” bi-directional interpolated pictures. As shown in FIG. 2, in order to decode encoded pictures being P-pictures or B-pictures, the picture transmission order in the digital video bit-stream is not the same as the desired picture display order.

A decoder adds a correction term to the block of predicted pixels to produce the reconstructed block. Typically, a video decoder receives the digital video bit-stream and generates decoded digital video information, which is stored in an external memory area in frame buffers. As described above and illustrated in FIG. 2, each macroblock of a P-picture can be coded with respect to the closest previous I-picture, or with respect to the closest previous P-picture. That is, each macroblock of a B-picture can be coded by forward prediction from the closest past I-picture or P-picture, by backward prediction from the closest future I-picture or P-picture, or bi-directionally using both the closest past I-picture or P-picture and the closest future I-picture or P-picture. Therefore, in order to properly decode all the types of encoded pictures and display the digital video information, at least the following three frame buffers are required:

1. Past reference frame buffer

2. Future reference frame buffer

3. Decompressed B-frame buffer

Each buffer must be large enough to hold a complete picture's worth of digital video data (e.g., 720×480 pixels for MPEG-2 Main Profile/Main Level). Additionally, as is well known by a person of ordinary skill in the art, both luminance data and chrominance data require similar processing. In order to keep the cost of the video decoder products down, an important goal has been to reduce the amount of external memory (i.e., the size of the frame buffers) required to support the decode function.

For example, different related art methods reduce memory required for decompression of a compressed frame by storing frame data in the frame buffers in a compressed format. During operations, the compressed frame is decompressed by the decoder module to obtain a decompressed frame. However, the decompressed frame is then compressed by an additional compression module to obtain a recompressed frame, which is stored in the memory. Because the frames that are used in the decoding of other frames or that are displayed are stored in a compressed format, the decoder system requires less memory. However, some drawbacks exist in the related art. Firstly, the recompressed reference frame does not allow easily performing random access of a prediction block within regions of the recompressed reference frames stored in the memory. Secondly, the additional recompression and decompression modules dramatically increase the hardware cost and power consumption of the decoder system. Additionally, the recompression and decompression process causes a loss of precision of the original reference frame video data.

### SUMMARY

Methods and systems for decoding pictures from a digital video bit-stream are provided. An exemplary embodiment of a method for decoding pictures from a digital video bit-stream comprises: providing a first buffer and a second buffer being overlapped with the first buffer by an overlap region; decoding a first encoded picture from the bit-stream and storing a corresponding first picture into the first buffer; and decoding a second encoded picture from the bit-stream according to the first picture being stored in the first buffer, and storing a corresponding second picture into the second buffer.

An exemplary embodiment of a digital video decoder system is disclosed comprising a first buffer; a second buffer being overlapped with the first buffer by an overlap region; and a picture decoder for decoding a first encoded picture from the bit-stream and storing a corresponding first picture into the first buffer; and decoding a second encoded picture from the bit-stream according to the first picture being stored in the first buffer, and storing a corresponding second picture into the second buffer.

Another exemplary embodiment of a method for decoding pictures from a digital video bit-stream is disclosed. The method comprises providing a first buffer; providing a second buffer being overlapped with the first buffer by an overlap region; receiving bits from the digital video bit-stream; decoding a first encoded picture from the bit-stream and storing a corresponding first picture into the first buffer; storing bits from the bit-stream corresponding to at least a portion of the first encoded picture; decoding a second encoded picture from the bit-stream according to the first picture being stored in the first buffer, and storing a corresponding second picture into the second buffer; redecoding the stored bits to restore at least a portion of the first picture in the first buffer; and decoding a third encoded picture from the bit-stream according to the first picture being stored in the first buffer.

### BRIEF DESCRIPTION OF DRAWINGS

FIG. 1 is a diagram illustrating a conventional block-matching process utilized to perform motion estimation.

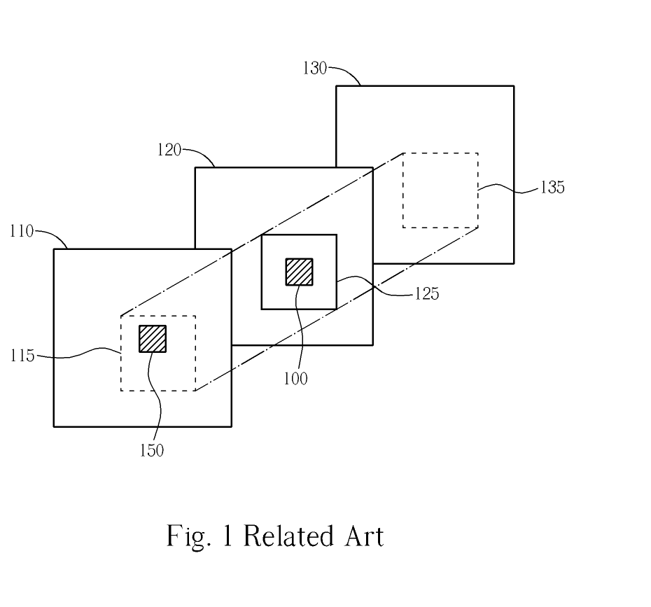

FIG. 2 is a diagram illustrating the difference between the display order and the transmission order of pictures of the MPEG-2 Standard.

FIG. 3 shows a block diagram of an exemplary embodiment of a digital video decoder system.

FIG. 4 shows a more detailed memory map to illustrate the relationship between the first reference buffer and the bi-direction buffer in the buffer unit of FIG. 3 according to this exemplary embodiment.

FIG. 5 shows a table describing different maximum ranges of motion vectors as a function of f_code[s][t] for the MPEG2 13818-2 specification.

FIG. 6 shows a flowchart describing an exemplary embodiment of a method for decoding pictures from a digital video bit-stream.

FIG. 7 shows an example decoding process illustrating decoding pictures from a digital video bit-stream IN according to the flowchart of FIG. 6.

FIG. 8 shows another example decoding process illustrating decoding pictures from a digital video bit-stream according to another exemplary embodiment.

### DETAILED DESCRIPTION

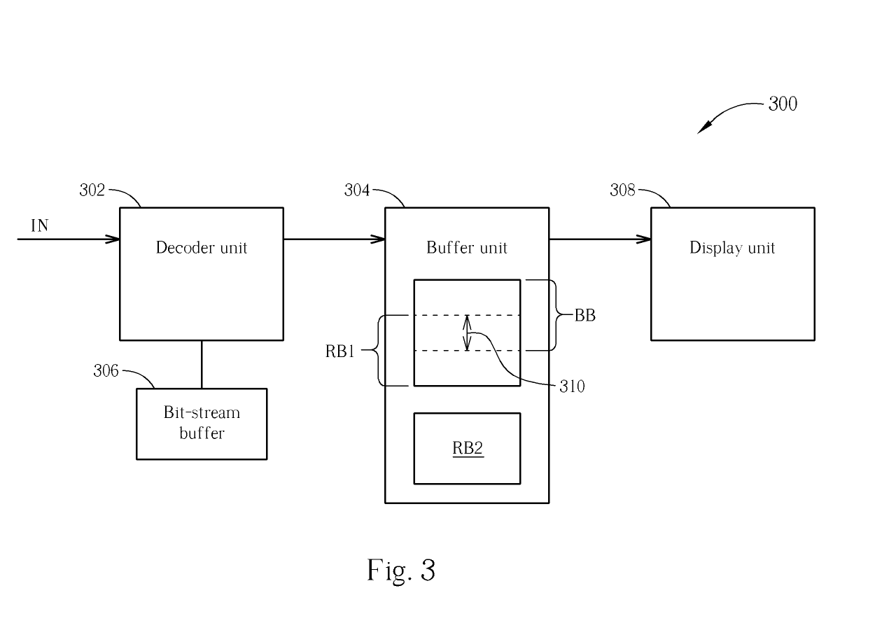

FIG. 3 shows a block diagram of an exemplary embodiment of a digital video decoder system 300. The video decoder system 300 includes a decoder unit 302, a buffer unit 304, a display unit 308, and a bit-stream buffer 306. The buffer unit 304 includes a first buffer RB1 and a second buffer BB being overlapped with the first buffer RB1 by an overlap region 310. Additionally, the buffer unit 304 further includes a third buffer RB2 as shown in FIG. 3.

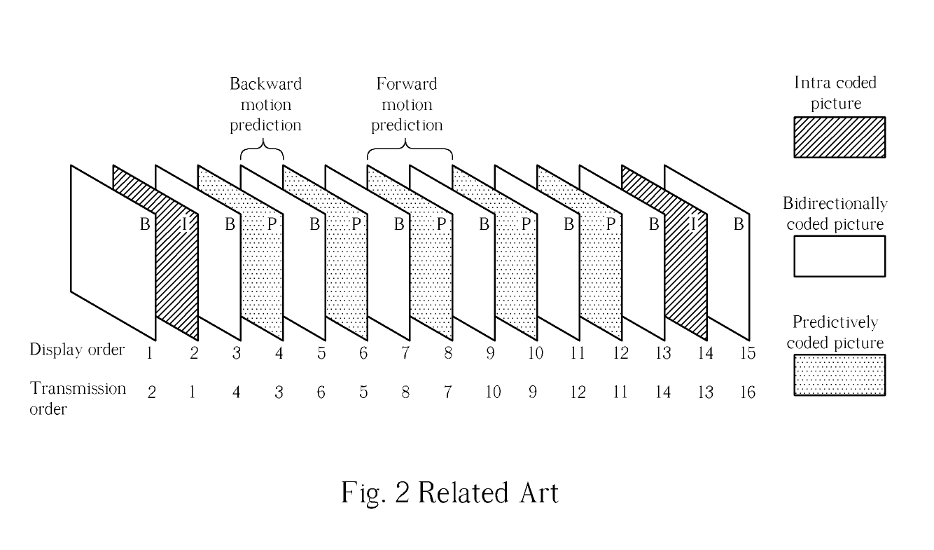

In the following operational description of this embodiment, assume that encoded frames (i.e., encoded pictures) of an MPEG-2 bit-stream IN are received in a transmission order such as shown in FIG. 2. Received encoded frames are decoded by the decoder system 300 and displayed in a display order to thereby form a video sequence. In this exemplary embodiment, the three picture buffers RB1, RB2, BB shown in FIG. 3 can also be referred to as a first reference buffer (RB1), a second reference buffer (RB2), and a bidirectional buffer (BB). The three buffers RB1, RB2, BB are located within the buffer unit 304, which is implemented, in some embodiments, as a memory storage unit such as a dynamic random access memory (DRAM). The first reference buffer RB1 and the second reference buffer RB2 store decoded reference pictures (i.e., either I-pictures or P-pictures), and the bi-direction buffer BB stores decoded B-pictures.

As shown in FIG. 3, the bi-directional buffer BB is overlapped with the first reference buffer RB1 by an overlap region 310, where the overlap region 310 of the first reference buffer RB1 and the bi-directional buffer BB is a single storage area. When new data is written to the overlap region 310, the new data will replace any data already stored in the overlap region 310. Therefore, writing new data to the first reference buffer RB1 will overwrite some of the old data stored in the bi-directional buffer BB, and vice versa. More specifically, the overwritten data is the data of the bi-directional buffer BB that was stored in the overlap region 310.

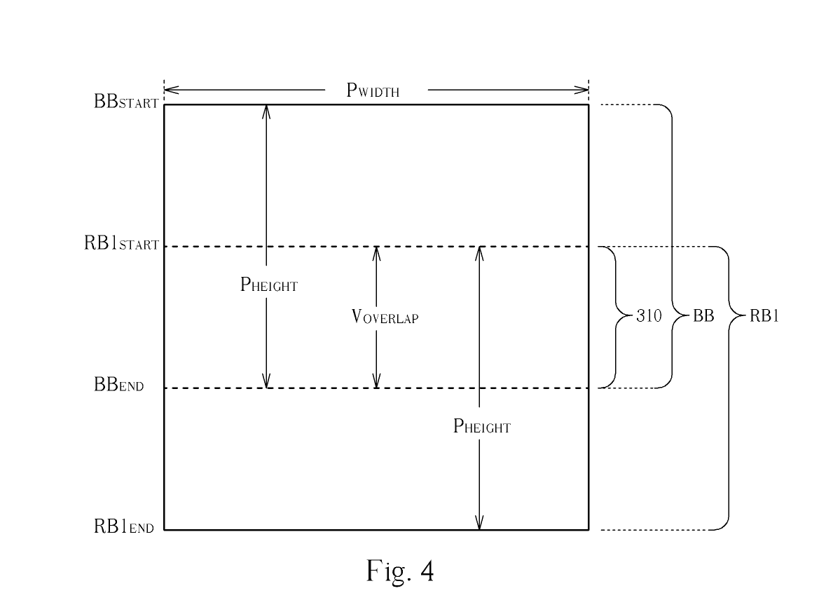

FIG. 4 shows a more detailed memory map to illustrate the relationship between the first reference buffer RB1 and the bi-direction buffer BB in the buffer unit 304 of FIG. 3 according to the exemplary embodiment. Referring to FIG. 4, the first reference buffer RB1 and the bi-directional buffer BB are formed within the buffer unit 304. The bi-directional buffer BB1 starts at a starting address BB_{START} and ends at an ending address BB_{END}. Likewise, the first reference buffer RB1 starts at a starting address RB1_{START} and ends at an ending address RB1_{END}. Please note that the first reference buffer RB1, the bi-directional buffer BB, and also the second reference buffer RB2 (not shown in FIG. 4) have a height corresponding to a decoded picture's vertical height P_{HEIGHT} and a width corresponding to a decoded picture's horizontal width P_{WIDTH}. Within the buffer unit 304, the ending address BB_{END} of the bi-directional buffer BB is equal to the starting address RB1_{START} of the first reference buffer RB1 plus the size of the overlap region 310. Therefore, as shown in FIG. 4, the size of the overlap region 310 is the picture width P_{WIDTH} multiplied by the vertical overlap V_{OVERLAP}, where the vertical overlap V_{OVERLAP} is the vertical height of the overlapped region 310.

According to the MPEG-2 standard, pictures of the received digital video bit-stream IN are encoded utilizing motion prediction. A block-matching algorithm that compares the current block to every candidate block within the search range is called a “full search block-matching algorithm.” In general, a larger search area produces a more accurate motion vector. However, the required memory bandwidth of a full search block-matching algorithm is proportional to the size of the search area. For example, if a full search block-matching algorithm is applied on a macroblock of size 16×16 pixels over a search range of +N pixels with one pixel accuracy, it requires (2×N+1)² block comparisons. For N=16, 1089 16×16 block comparisons are required. Because each block comparison requires 16×16, or 256 calculations, this algorithm consumes considerable memory bandwidth and is computationally intensive. Therefore, to reduce memory and computational requirements in the encoder, smaller search areas are typically used in related art encoders.

This smaller search area means reduced size of motion vectors in the incoming bit-stream IN. That is, a macroblock near the bottom of a B-picture (or a P-picture) will not be decoded from a macroblock near the top of a reference picture (.i.e., an I-picture or a P-picture). For this reason, the exemplary embodiment overlaps the first reference buffer RB1 with the bi-directional buffer BB to reduce the frame buffer memory requirement of the digital video decoder system 300. The size of the overlap region corresponds to the predetermined maximum decodable vertical prediction distance of the incoming digital video bit-stream IN. Therefore, frame buffer memory requirements are reduced by overlapping the bi-directional buffer BB with the first reference buffer RB1. In this overlapped situation, successful decoding can still be performed up to a predetermined maximum decodable vertical prediction distance.

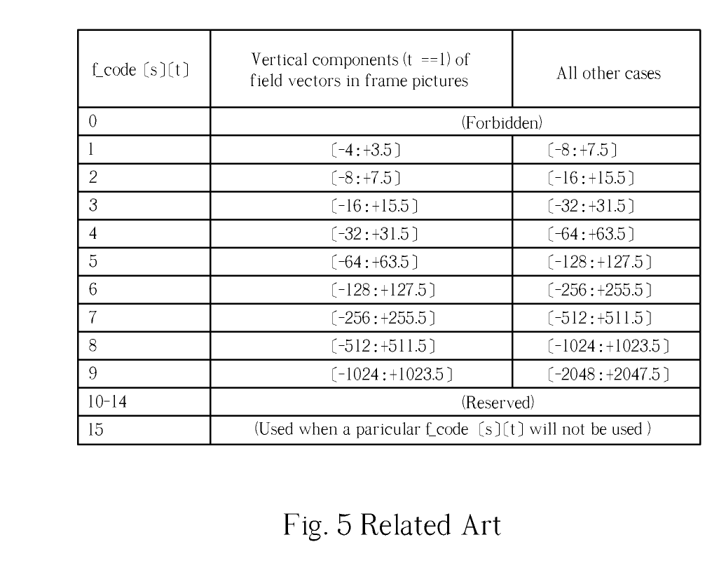

FIG. 5 shows a table describing different maximum ranges of motion vectors as a function of f_code[s][t] for the MPEG2 13818-2 specification. To determine the vertical size V_{OVERLAP} of the overlap region 310, a predetermined maximum decodable vertical prediction distance for the motion compensation used in the received bit-steam IN must be chosen. That is, it should be determined what is the maximum possible pointing range of a motion vector given the format of the received bit-steam IN. For example, as shown in FIG. 5, in the MPEG-2 specification, the parameter f_code specifies the maximum range of a motion vector. As is explained in the MPEG-2 standard and is well known by a person of ordinary skill in the art, an f_code[s][t] having s with a value of 0 or 1 represents either a forward or backward motion vector, respectively. An f_code[s][t] having t with a value of 0 or 1 represents the horizontal and vertical component. In frame pictures, the vertical component of field motion vectors is restricted so that they only cover half the range that is supported by the f_code that relates to those motion vectors. This restriction ensures that the motion vector predictors will always have values that are appropriate for decoding subsequent frame motion vectors. FIG. 5 summarizes the different sizes of motion vectors that may be coded as a function of the f_code. In FIG. 5, the f_code_vertical_max is the maximum value at f_code[s][1], where s with a value of 0 or 1 means forward or backward motion vector, respectively.

In this example, to determine the vertical overlap size V_{OVERLAP} of the overlap region 310, firstly define Vmax as the maximum negative vertical component of a motion vector with f_code being equal to f_code_vertical_max. For simplicity, assume the Vmax, picture height VH_{EIGHT}, and vertical overlap size V_{OVERLAP} are multiples of 16, i.e., multiples of the macroblock height. Then, the relationship between Vmax, V_{HEIGHT}, and V_{OVERLAP} can be expressed with the following Formula 1:
Vheight=Vmax+V_{OVERLAP} Formula 1

As shown by Formula 1, the larger the vertical overlap size V_{OVERLAP}, the smaller the maximum negative vertical component of a motion vector Vmax. For example, assume the first reference buffer RB1 is overlapped with the bidirectional buffer BB having an overlap region 310 with a vertical height V_{OVERLAP} of twenty-six macroblocks (i.e., 26*16=416 lines), and that the vertical picture height V_{HEIGHT} is a height of thirty macroblocks (i.e, 30* 16=480 lines). Therefore, using Formula 1, the maximum Vmax is derived as Vmax=V_{HEIGHT}−V_{OVERLAP}=480−416=64. Looking up the value of 64 from the table shown in FIG. 5, the f_code_vertical_max is found to be 4. That is, in the “All other cases” column of FIG. 5, the maximum f_code that does not exceed a negative vertical component of -64 is f_code_vertical_max=4. Therefore, in this example embodiment having a vertical overlap size V_{OVERLAP} of 416 lines, a prediction block can be pointed to by motion vector having a vertical component up to a maximum value of 64. That is, motion vectors having vertical components of 64 or less can be successfully fetched from the first reference picture stored in the first reference buffer RB1 before the prediction block is overwritten by storing the current decoding B-picture into the overlap region 310 of the bi-directional buffer BB.

Hence, in this exemplary embodiment, the overlap region 310 has a vertical size V_{OVERLAP} equal to 416 lines being overlapped between the first reference buffer RB1 and the bi-directional buffer BB, and total required memory size of the decoder system 300 is thereby reduced. The overlapping the first reference buffer RB1 and the bi-directional buffer BB means that only video bit-streams IN with f_code smaller than or equal to f_code_vertical_max (e.g., with f_code_vertical_max<=4 in this example) can be decoded. As will be clear to a person of ordinary skill in the art after reading this description, if the vertical overlap size V_{OVERLAP} is decreased, the f_code_vertical_max is increased. That is, with a reduced vertical overlap size V_{OVERLAP}, bit-streams with a larger f_code, i.e. bit-streams encoded with larger search ranges, can be successfully decoded. However, as previously mentioned, related art encoders are typically implemented with limited and small search ranges due to computational power and cost considerations. Hence, even with a reduced f_code_vertical_max, most bit-streams can still be decoded even with a large overlap size V_{OVERLAP}. This overlap region 310 according to the exemplary embodiment greatly reduces the required memory size of the digital video decoder system 300. It is an additional benefit of the exemplary embodiment that the data of the decoded pictures stored in the frame buffers RB1, BB, RB2 can be in an uncompressed format. Therefore random accessing of prediction blocks within the decoded pictures is possible without complex calculations or pointer memory used to specify block addressing.

It should also be noted that the V_{OVERLAP} values of luminance and chrominance components are different. Since the sampling structure of MPEG-2 is usually 4:2:0, the vertical height of the chrominance component is one half that of the luminance component. Additionally, the search range of the chrominance component is also halved. Hence, in the above example, the V_{OVERLAP} of the chrominance frame buffers is also halved. That is, in the above example, the V_{OVERLAP} of the chrominance frame buffers can at most be 208 lines, which will allow motion vectors having vertical components of 32 or less to be successfully fetched from the first reference picture stored in the first reference buffer RB1 before the prediction block is overwritten by storing the current decoding B-picture into the overlap region 310 of the bi-directional buffer BB.

When decoding an MPEG-2 bit-steam, however, a potential problem arises with the occurrence of two (or more) successive B-pictures. In this case, the 2^{nd} B-picture requires the decoded picture stored in the first reference buffer RB1. However, the data stored in the overlap region 310 of the first reference buffer RB1 has already been overwritten with data from the first B-picture stored in the bi-directional BB buffer. To overcome this difficulty, the digital video decoder system 300 includes the bit-stream buffer 306 for storing bits from the bit-stream IN corresponding to at least a portion of the first encoded picture. For example, in some embodiments, the bit-stream buffer stores the full first encoded picture from the incoming bit-stream IN. In this way, before decoding the second B-picture, the data of the first encoded picture stored in the bit-stream buffer 306 is used by the picture decoder 302 to reconstruct the first picture in the first reference buffer RB1. Afterwards, the picture decoder 302 can successfully decode the second encoded B-picture from the incoming bit-stream IN according to the first picture stored in the first reference buffer RB1. It should also be emphasized that because the bits of the bit-steam IN corresponding to the first encoded picture are already in a compressed format (i.e., are “encoded”), the memory requirement of the bit-stream buffer 306 is much less than the size of the overlap region 310. Therefore, an overall memory savings is achieved according to the exemplary embodiment.

In some embodiments, to further reduce the storage requirements of the bit-stream buffer 306, only the bits of the bit-steam corresponding to an area of the first picture being in the overlap region are stored in the bit-stream buffer 306. In this regard, to decode the second encoded B-picture, the decoder unit 306 simply redecodes the stored bits in the bit-stream buffer 306 to restore only the area of the first picture being in the overlap region of the first reference buffer RB1. To determine which bits of the bit-steam correspond to the area of the first picture being in the overlap region, when the decoder unit 302 first decodes the first encoded picture, the encoded bits that result in data being stored in the overlap region 310 of the first reference buffer RB1 are stored in the bit-stream buffer 306.

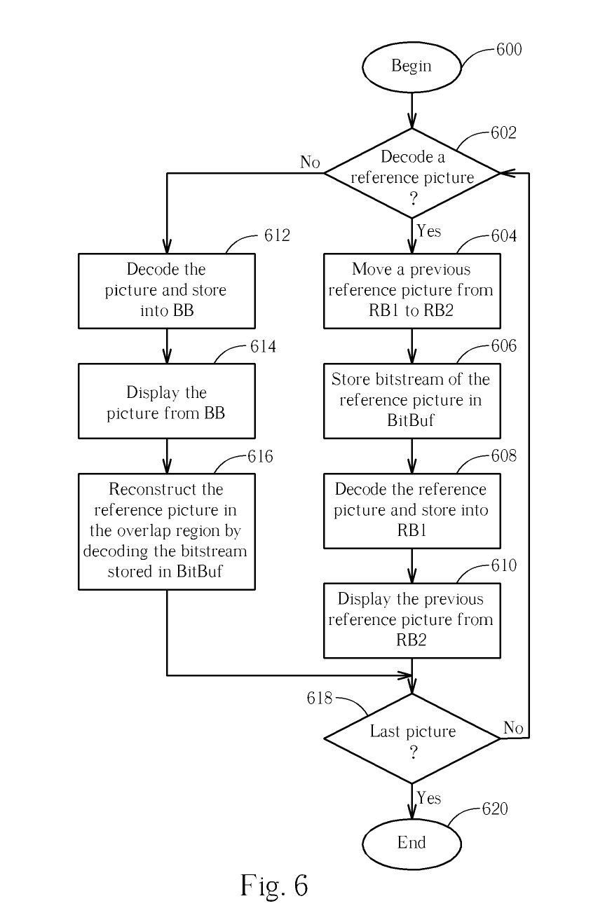

FIG. 6 shows a flowchart describing an exemplary embodiment of a method for decoding pictures from a digital video bit-stream IN. In this exemplary embodiment, the digital video bit-stream IN is a Moving Picture Experts Group (MPEG) digital video stream. Additionally, this embodiment successfully performs video decoding when two successive encoded B-pictures are received between two encoded reference frames (i.e, I-pictures or P-pictures). Please also note, provided that substantially the same result is achieved, the steps of the flowchart shown in FIG. 6 need not be performed in the exact order shown and need not be contiguous, that is, other steps can be intermediate. As depicted, the method for decoding pictures from a digital video bit-stream IN contains the following steps:

Step 600: Begin picture decoding operations.

Step 602: Is the incoming encoded picture a reference picture? For example, is the encoded picture in the digital video bit-steam IN a P-picture or an I-picture? If yes, proceed to step 604; otherwise, proceed to step 612.

Step 604: Move the previous reference picture from the first reference buffer RB1 to the second reference buffer RB2.

Step 606: Store bits from the bit-stream IN corresponding to at least a portion of the first encoded picture. For example, the bits corresponding to at least the overlap region 310 can be stored into a bit-steam buffer 306.

Step 608: Decode the first encoded reference picture and store a corresponding first reference picture into the first reference buffer RB1.

Step 610: Display the previous reference picture from the second reference buffer RB2.

Step 612: Decode an encoded non-reference picture and store a corresponding non-reference picture into the bi-directional buffer BB.

Step 614: Display the non-reference picture from the bi-directional buffer BB.

Step 616: Reconstruct the first reference picture in at least the overlap region by redecoding the bits stored in Step 606.

Step 618: Is the current encoded picture the last picture of the digital bit-stream IN? If yes, proceed to step 626; otherwise, return to step 602.

Step 620: End picture decoding operations.

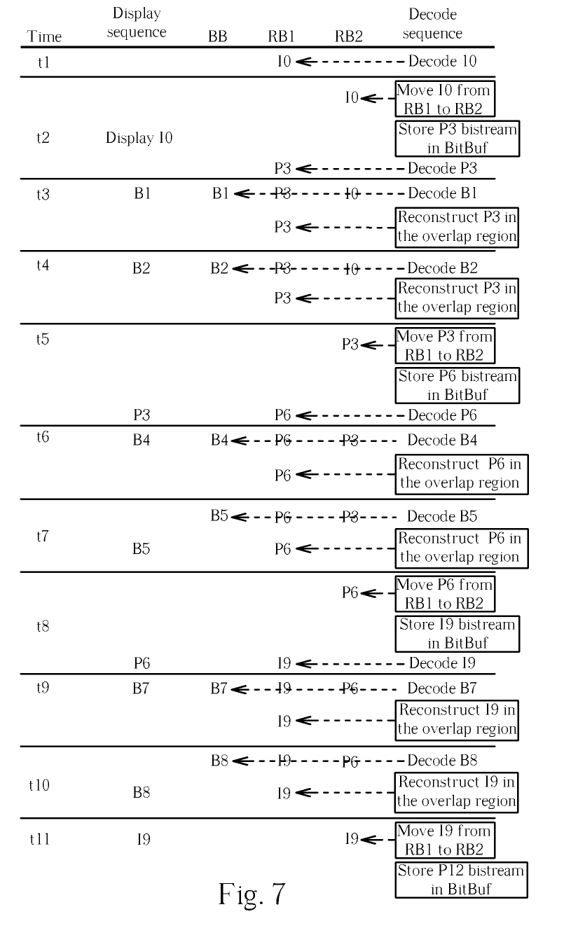

FIG. 7 shows an example decoding process illustrating decoding pictures from a digital video bit-stream IN according to the flowchart of FIG. 6. In this example, assume that frames are taken from the beginning of a video sequence. In this example, there are two encoded B-frames between successive encoded reference frames (i.e I or P frames). The decode order, the display order, and the steps performed at different times (t) are as follows:

| | Time (t) | | | | | | | | | | |
|---|---|---|---|---|---|---|---|---|---|---|---|
| | 1 | 2 | 3 | 4 | 5 | 6 | 7 | 8 | 9 | 10 | 11 . . . |
| Decode order | I0 | P3 | B1 | B2 | P6 | B4 | B5 | I9 | B7 | B8 | P12 . . . |
| Display order | | I0 | B1 | B2 | P3 | B4 | B5 | P6 | B7 | B8 | I9 . . . |

At time t1:

Decode reference picture 10 and store result into RB1 without displaying any picture. (step 608)

At time t2:

(1) Move the decoded picture 10 from RB1 to RB2. (step 604)

(2) Decode reference picture P3 and store result into RB1. (step 608)

(3) Store bits from the bit-stream IN corresponding to reference picture P3 into a bit-stream buffer 306. (step 606)

(4) Display decoded picture 10 stored in RB2. (step 610)

At time t3:

(1) Decode non-reference picture B2 and store result into BB. (step 612)

(2) Display the decoded non-reference picture B1 stored in BB. (step 614)

(3) Since the bi-directional buffer BB is overlapped with the first reference buffer RB1, the part of the decoded reference picture P3 stored within the overlapped region 310 of the first reference buffer RB1 is overwritten by the decoded non-reference picture B1 while storing the decoded non-reference picture Bi into the bi-directional buffer BB at time t3. Hence, reconstruct picture P3 in the overlap region 310 by fetching the corresponding P3 bit-stream from the bit-stream buffer 306 and redecoding into picture P3 in the overlap region 310 according to the reference picture 10 stored in the second reference buffer RB2. (step 616)

At time t4:

(1) A second successive non-reference picture B2 needs to be decoded picture B2. Therefore, decode the second non-reference picture B2 according to both the reference picture 10 stored in the second reference buffer RB2 and the redecoded reference picture P3 stored in the first reference buffer RB1, and then store the resulting decoded picture into the bi-directional buffer BB. (step 612)

(2) Next, display the decoded picture B2 stored in the bi-directional buffer BB. (step 614)

(3) Similarly, reconstruct picture P3 in the overlap region 310 by fetching the corresponding P3 bit-stream from the bit-stream buffer 306 and redecoding into picture P3 in the overlap region 310 according to the reference picture 10 stored in the second reference buffer RB2. (step 616)

At time t5:

(1) A new reference picture P6 needs to be decoded. Therefore, move the decoded picture P3 from the first reference buffer RB1 to the second reference buffer RB2. (step 604)

(2) Decode reference picture P6 and store result into RB1. (step 608)

(3) Store bits from the bit-stream IN corresponding to reference picture P6 into the bit-stream buffer 306. (step 606)

(4) Display decoded picture P3 stored in RB2. (step 610)

Continuing, the operations at times t6, t7, t8 and t9, t10, t11 are similar to the operations at times t3, t4, and t5. Note that at time t2, in some embodiments, all of the bits from the bit-stream IN corresponding to encoded picture P3 are stored into the bit-stream buffer 306. Alternatively, only the bits from the bit-stream IN corresponding to picture P3 in the overlap region are stored into the bit-stream buffer 306 to reduce the memory requirements of the bit-steam buffer 306. Also note, at time t5, storing bits from the bit-stream corresponding to picture P6 will overwrite the previously stored bits from the bit-stream corresponding to picture P3 in the bit-stream buffer 306. Similarly, at time t8, storing bits from the bit-stream corresponding to picture 19 will overwrite the previously stored bits from the bit-stream corresponding to picture P6 in the bit-stream buffer 306. Finally, at some times such as t4, the picture decoder must decode both part of a previous picture in the overlap region 310 and a current picture according to the redecoded picture. Therefore, the decoding speed (e.g., the clock rate) of the picture decoder should be sufficient to complete both these decode operations within time t4.

Although the foregoing description has been made with reference to encoded frames (i.e., encoded pictures) of an MPEG-2 bit-stream IN, please note that the MPEG-2 bit-steam is used as an example of one embodiment. The present invention is not limited to only being implemented in conjunction with MPEG-2 bit-steams. In a more general embodiment of a digital video decoder, the second buffer BB is used to store pictures decoded according to a reference picture in the first buffer RB1.

More specifically, in some embodiments, the buffer unit 304 only includes the first buffer RB1 and the second buffer BB. In this regard, the picture decoder 302 decodes a first encoded picture from the bit-stream IN and stores a corresponding first decoded picture into the first reference buffer RB1. For example, the first encoded picture could be a reference picture type, which is used to decode a second encoded picture from the bit-stream IN. Afterwards, the picture decoder 302 decodes the second encoded picture from the bit-stream IN according to the first picture being stored in the first buffer RB1. For example, the second encoded picture could be a non-reference picture or a reference picture requiring the decoder unit 302 to refer to the first picture being stored in the first reference buffer RB1. While decoding the second encoded picture from the bit-stream IN according to the first picture being stored in the first buffer RB1, the decoder unit 302 simultaneously stores the corresponding second picture into the second buffer BB. In this way, data from the second picture overwrites data of the first picture in the overlap region 310. Because the first buffer RB1 and the second buffer BB are overlapped by the overlap region BB, frame buffer memory requirements are moderated. Additionally, the data of the decoded pictures stored in the frame buffers RB1, BB is in an uncompressed format. Therefore random accessing of prediction blocks within the decoded pictures is possible without complex calculations or pointer memory used to specify block addressing.

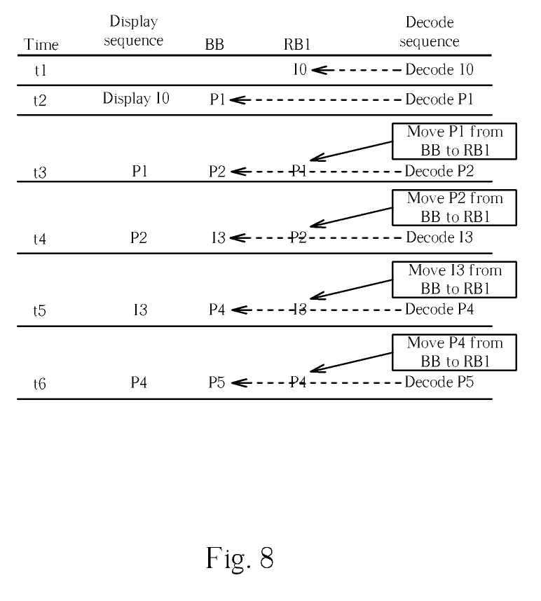

In some video compression standards, there only exist reference pictures (I-picture or P-picture) but no non-reference picture (B-picture) in the video bit-stream. For example, in ISO/IEC 14496-2 MPEG4 video compression standard, a digital video bit-stream conforming to the simple profile contains only I-VOP (video object plane) and/or P-VOP but no B-VOP. FIG. 8 shows another example decoding process illustrating decoding pictures from a digital video bit-stream IN. However, in this example, there are no encoded B-pictures and therefore only a first buffer RB1 and a second buffer BB are required. Moreover, the second BB buffer is overlapped with the first RB1 buffer by an overlap region. Assuming that frames are taken from the beginning of a video sequence, the decode order, the display order, and the steps performed at different times (t) are as follows:

Time (t)

| | 1 | 2 | 3 | 4 | 5 | 6 . . . |
|---|---|---|---|---|---|---|
| Decode order | I0 | P1 | P2 | I3 | P4 | P5 . . . |
| Display order | | I0 | P1 | P2 | I3 | P4 . . . |

At time t1:

(1) Decode reference picture 10 and store result into RB1 without displaying any picture.

At time t2:

(1) Display decoded picture 10.

(2) Decode reference picture P1 and store result into BB.

At time t3:

(1) Move the decoded picture P1 from BB to RB1.

(2) Decode reference picture P2 and store result into BB.

(3) Display decoded picture P1.

At time t4:

(1) Move the decoded picture P2 from BB to RB1.

(2) Decode reference picture 13 and store result into BB.

(3) Display decoded picture P2.

At time t5:

(1) Move the decoded picture 13 from BB to RB1.

(2) Decode reference picture P4 and store result into BB.

(3) Display decoded picture 13.

At time t6:

(1) Move the decoded picture P4 from BB to RB1.

(2) Decode reference picture P5 and store result into BB.

(3) Display decoded picture P4.

The present disclosure overlaps a first frame buffer with a second frame buffer so that frame buffer memory requirements of a digital video decoder system are reduced. The second frame buffer is overlapped with the first frame buffer by an overlap region. A picture decoder decodes a first encoded picture from an incoming bit-stream and stores a corresponding first picture into the first frame buffer. The picture decoder then decodes a second encoded picture from the bit-stream according to the first picture being stored in the first frame buffer, and stores a corresponding second picture into the second buffer. Overall memory requirements are moderated accordingly. Additionally, the data of the decoded pictures can be stored in the frame buffers is in an uncompressed format, which allows direct random accessing of prediction blocks within the decoded pictures.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for decoding pictures from a digital video bit-stream, the method comprising:
providing a first buffer and a second buffer being overlapped with the first buffer by an overlap region;
decoding a first encoded picture from the bit-stream and storing a corresponding first picture into the first buffer; and
decoding a second encoded picture from the bit-stream according to the first picture being stored in the first buffer, and storing a corresponding second picture into the second buffer.

2. The method of claim 1, further comprising:
storing bits from the bit-stream corresponding to at least a portion of the first encoded picture;
redecoding the stored bits to restore at least a portion of the first picture in the first buffer; and
decoding a third encoded picture from the bit-stream according to the first picture being stored in the first buffer.

3. The method of claim 2, wherein storing bits from the bit-stream corresponding to at least a portion of the first encoded picture further comprises storing at least bits from the bit-stream corresponding to an area of the first picture being in the overlap region.

4. The method of claim 3, wherein redecoding the stored bits to restore at least a portion of the first picture in the first buffer further comprises redecoding the stored bits to restore at least the area of the first picture being in the overlap region.

5. The method of claim 2, further comprising the following steps:
moving the first picture to a third buffer;
after decoding the second encoded picture from the bit-stream, displaying the second picture being stored in the second buffer;
after decoding the third encoded picture from the bit-stream, displaying the third picture; and
displaying the picture being stored in the third buffer.

6. The method of claim 1, further comprising while decoding the second encoded picture from the bit-stream according to the first picture being stored in the first buffer, simultaneously storing the corresponding second picture into the second buffer.

7. The method of claim 1, further comprising decoding a third encoded picture from the bit-stream, and storing a corresponding third picture into a third buffer; wherein decoding the second encoded picture from the bit-stream is further performed according to the third picture being stored in the third buffer.

8. The method of claim 1, wherein the overlap region of the first buffer and the second buffer is a single storage area.

9. The method of claim 8, wherein the first buffer and the second buffer are formed within a single buffer unit, an ending address of the first buffer being equal to a starting address of the second buffer plus a size of the overlap region.

10. The method of claim 1, wherein pictures of the digital video stream are encoded utilizing motion prediction, and a size of the overlap region corresponds to a predetermined maximum decodable vertical prediction distance.

11. The method of claim 1, wherein the digital video bit-stream is a Moving Picture Experts Group (MPEG) digital video stream.

12. The method of claim 11, wherein the first encoded picture corresponds to a reference picture being a predictive coded (P) picture or an intra coded (I) picture, and the second encoded picture corresponds to a non-reference picture being a bidirectional coded (B) picture or a reference picture being a predictive coded (P) picture.

13. A digital video decoder system comprising:
a first buffer;
a second buffer being overlapped with the first buffer by an overlap region; and
a picture decoder for decoding a first encoded picture from the bit-stream and storing a corresponding first picture into the first buffer; and decoding a second encoded picture from the bit-stream according to the first picture being stored in the first buffer, and
storing a corresponding second picture into the second buffer.

14. The digital video decoder system of claim 13, further comprising:
a bit-stream buffer for storing bits from the bit-stream corresponding to at least a portion of the first encoded picture;
wherein the picture decoder is further for redecoding the stored bits in the bit-stream buffer to restore at least a portion of the first picture in the first buffer; and then decoding a third encoded picture from the bit-stream according to the first picture being stored in the first buffer.

15. The digital video decoder system of claim 14, wherein the bit-stream buffer is further for storing at least bits from the bit-stream corresponding to an area of the first picture being in the overlap region.

16. The digital video decoder system of claim 15, wherein when redecoding the stored bits in the bit-stream buffer to restore at least a portion of the first picture in the first buffer, the picture decoder redecodes the stored bits in the bit-stream buffer to restore at least the area of the first picture being in the overlap region.

17. The digital video decoder system of claim 14, further comprising a display unit for displaying the second picture being stored in the second buffer after the second encoded picture has been decoded,; displaying the third picture after the third encoded picture has been decoded,; and displaying the first picture been restored.

18. The digital video decoder system of claim 13, wherein while decoding the second encoded picture from the bit-stream according to the first picture being stored in the first buffer, the picture decoder simultaneously stores the corresponding second picture into the second buffer.

19. The digital video decoder system of claim 13, further comprising:
a third buffer;
wherein the picture decoder is further for decoding a third encoded picture from the bit-stream, and storing a corresponding third picture into the third buffer; and decoding the second encoded picture from the bit-stream further according to the third picture being stored in the third buffer.

20. The digital video decoder system of claim 13, wherein the overlap region of the first buffer and the second buffer is a single storage area.

21. The digital video decoder system of claim 20, wherein the first buffer and the second buffer are formed within a single buffer unit, an ending address of the first buffer being equal to a starting address of the second buffer plus a size of the overlap region.

22. The digital video decoder system of claim 13, wherein pictures of the digital video stream are encoded utilizing motion prediction, and a size of the overlap region corresponds to a predetermined maximum decodable vertical prediction distance.

23. The digital video decoder system of claim 13, wherein the digital video bit-stream is a Moving Picture Experts Group (MPEG) digital video stream.

24. The digital video decoder system of claim 23, wherein the first encoded picture corresponds to a reference picture being a predictive coded (P) picture or an intra coded (I) picture, and the second encoded picture corresponds to a non-reference picture being a bi-directional coded (B) picture or a reference picture being a predictive coded (P) picture.

25. A method for decoding pictures from a digital video bit-stream, the method comprising:
providing a first buffer;
providing a second buffer being overlapped with the first buffer by an overlap region;
receiving bits from the digital video bit-stream;
decoding a first encoded picture from the bit-stream and storing a corresponding first picture into the first buffer;
storing bits from the bit-stream corresponding to at least a portion of the first encoded picture;
decoding a second encoded picture from the bit-stream according to the first picture being stored in the first buffer, and storing a corresponding second picture into the second buffer;
redecoding the stored bits to restore at least a portion of the first picture in the first buffer; and
decoding a third encoded picture from the bit-stream according to the first picture being stored in the first buffer.
